(19) United States
(12) Patent Application Publication
(10) Pub. No.: US 2003/0048699 A1
(43) Pub. Date: Mar. 13, 2003

(54) Circuit for measuring time of arrival of an asynchronous event

(75) Inventor: Vedon Otto, Burleson, TX (US)

Correspondence Address: JAMES E. BRADLEY, BRACEWELL & PATTERSON, LLP, P.O. BOX 61389, HOUSTON, TX, 77208-1389, US

(73) Assignee: Lockheed Martin Corporation

(21) Appl. No.: 10/062,938

(22) Filed: Feb. 1, 2002

Related U.S. Application Data
(60) Provisional application No. 60/322,085, filed on Sep. 12, 2001.

(51) Int. Cl. G04F 8/00; G04F 10/00

(52) U.S. Cl. 368/113

(57) ABSTRACT

A timing circuit for measuring time of arrival of an asynchronous event is disclosed. The timing circuit includes a counter, a register, a gray code-to-binary converter, and a cascade circuit. In response to a time of arrival of a trigger signal that denotes an occurrence of an asynchronous event, the counter generates a set of high-order binary bits and the register generates a set of gray code bits. The gray code-to-binary converter then converts the set of gray code bits to a set of low-order binary bits. Finally, the cascade circuit concatenates the high-order binary bits and the low-order binary bits to form the time of arrival of the asynchronous event.

### RELATED PATENT APPLICATION

The present patent application claims priority to copending application U.S. Ser. No. 60/322,085, filed on Sep. 12, 2001.

### BACKGROUND OF THE INVENTION

1. Technical Field

The present invention relates to digital circuits in general, and in particular to digital timing circuits. Still more particularly, the present invention relates to a digital timing circuit for measuring time of arrival of an asynchronous event.

2. Description of the Related Art

Certain applications require a determination of the arrival time of an asynchronous event. For example, the precise distance between a laser source and a target can be ascertained by determining the time of flight for a laser light to travel from the laser source to the target. The time when the laser light hits the target is considered as an asynchronous event. Other applications include locating a vessel by measuring the time of flight of an electromagnetic signal from three reference transponders to the vessel that carries a fourth transponder.

Most prior art digital timing circuits utilized to perform any of the abovementioned timing determination are typically not very precise. Common solution for increasing the precision of prior art timing circuits may include increasing the stability of reference clocks, increasing the speed of reference clocks, eliminating sources of certain kinds of jitter, etc. Although such solutions have been successful in a few applications, they are also very expensive to implement. In addition, such solutions have physical limitations as to how fast a reference clock can be made. Consequently, it is desirable to provide an improved digital timing circuit for measuring time of arrival of an asynchronous event. The digital timing circuit should be able to accurately measure the time of arrival of an asynchronous event without relying on expensive clock circuits.

### SUMMARY OF THE INVENTION

In accordance with a preferred embodiment of the present invention, a timing circuit includes a counter, a register, a gray code-to-binary converter, and a cascade circuit. In response to a time of arrival of a trigger signal that denotes an occurrence of an asynchronous event, the counter generates a set of high-order binary bits and the register generates a set of gray code bits. The gray code-to-binary converter then converts the set of gray code bits to a set of low-order binary bits. Finally, the cascade circuit concatenates the high-order binary bits and the low-order binary bits to form the time of arrival of the asynchronous event.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a timing circuit along with a pulse detection circuit, in accordance with a preferred embodiment of the present invention;

FIG. 2 is a block diagram of a delay circuit and a register within the timing circuit from FIG. 1, in accordance with a preferred embodiment of the present invention; and

FIG. 3 is an exemplary timing diagram depicting the waveforms generated by various delay lines of the delay circuit from FIG. 2, in accordance with a preferred embodiment of the present invention.

### DETAILED DESCRIPTION OF A PREFERRED EMBODIMENT

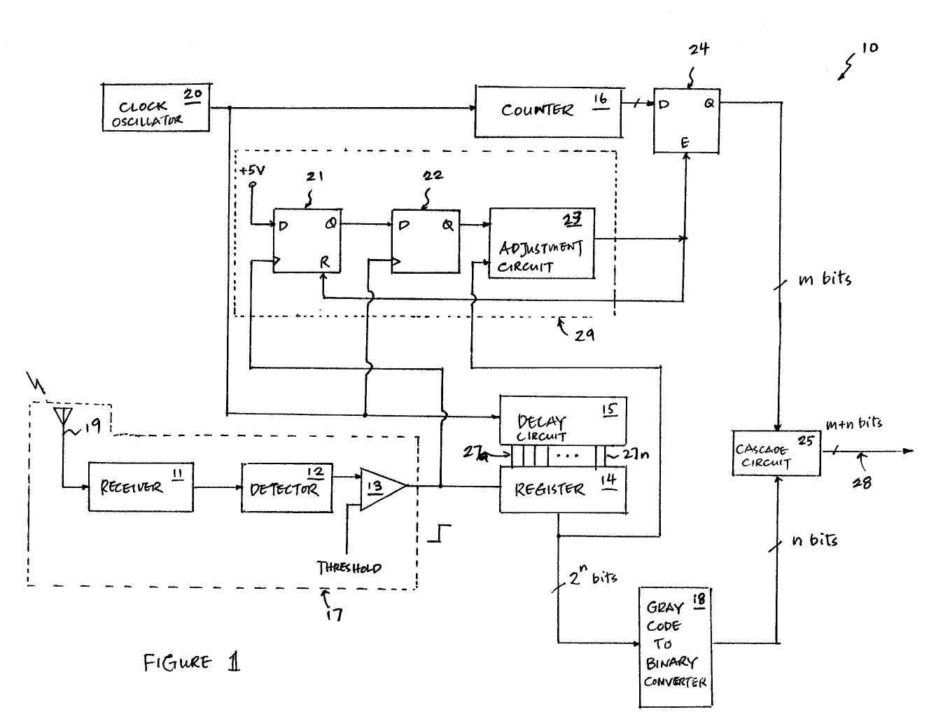

Referring now to the drawings and in particular to FIG. 1, there is illustrated a block diagram of a timing circuit 10 along with a pulse detection circuit 17, in accordance with a preferred embodiment of the present invention. As shown, pulse detecting circuit 17 includes an antenna 19 and a receiver 11 for receiving a signal. The signal can be, for example, an electromagnetic or acoustic signal. After amplifying and conditioning the signal received by antenna 19, receiver 11 sends the received signal to a detector 12. Detector 12, which is preferably formed by a series of operational amplifiers and diode detectors, then sends the received signal to a comparator 13 that includes a threshold input for eliminating spurious signals. Any signal occurs at the output of comparator 13 (i.e., the output of pulse detecting circuit 17) can be treated as a trigger signal that denotes an arrival of an asynchronous event.

In accordance with a preferred embodiment of the present invention, the actual time of arrival of the trigger signal is measured by a counter 16 and a register 14 that is coupled to a delay circuit 15. In the present implementation, counter 16 is an m-bit counter and register 14 is a 2″-bit register. A stable reference clock signal is provided to counter 16 by a clock oscillator 20. Counter 16 measures the “coarse” value of the time of arrival of the trigger signal. For example, m bits of counter 16 may yield the minute or second portion for the time of arrival of the trigger signal. The resolution of counter 16 is dictated by the period (i.e., 1/frequency) of a clock signal from clock oscillator 20. The number of bits within counter 16 dictates the unambiguous measurement interval for timing circuit 10. The unambiguous measurement interval is the time in which a clock measurement becomes unambiguous. For example, the unambiguous measurement interval for an analog clock is 12 hours, and the unambiguous measurement interval for counter 16 is preferably in the range of a few seconds. The bits of counter 16 are captured by a latch 24 (such as a D-type flip-flop circuit). The capture of m bits from counter 16 is activated by a trigger signal from the output of comparator 13, which is the same trigger signal received by register 14. As shown, the trigger signal from the output of comparator 13 activates an event circuit 29 that subsequently activates latch 24 via an enable input of latch 24 to capture m bits from counter 16. The activation of latch 24 must occur synchronously with the clock cycle of a clock signal from clock oscillator 20 in order to achieve reliable operations.

Event circuit 29 preferably includes an event flip-flop circuit 21, a synchronizing flip-flop circuit 22, and an adjustment circuit 23. The output of event flip-flip circuit 21 is coupled to the input of synchronizing flip-flop circuit 22 that preferably changes state on a rising edge of a clock signal from clock oscillator 20. The output of synchronizing flip-flop circuit 22 is coupled to a first input of adjustment circuit 23. The second input of adjustment circuit 23 receives 2″ output bits from register 14.

Register 14 is coupled to delay circuit 15 via multiple delay lines (or tap lines) 27a-27n. When a trigger signal (from the output of comparator 13) arrived at register 14, the state of delay circuit 15 is instantaneously captured by register 14. The detail of the capturing process is further explained infra. The 2″ bits output from register 14, which are in gray code form, are sent to a gray code-to-binary converter 18 that is well-known to those skilled in the art. Gray code-to-binary converter 18 then converts the 2″ gray code bits to n binary bits that represent the fraction of a clock period for the time of arrival of the trigger signal. The resolution of register 14 and also the resolution of gray code-to-binary converter 18 are dictated by the number of delay lines 27a-27n from delay circuit 15.

Delay circuit 15 is also provided with a stable reference clock signal by clock oscillator 20. Delay circuit 15, which preferably includes multiple delay elements (not shown), produces a delayed fraction of a clock signal from clock oscillator 20 at the output of each delay element. For example, if delay circuit 15 has 8 delay elements, then each of the delay lines provides a delay time equal to the fraction of the period of the clock signal from clock oscillator 20 divided by 8.

The purpose of adjustment circuit 23 is to compensate for any error resulting from multiple trigger signals (i.e., multiple asynchronous events) being captured. When a trigger signal is captured by a D-type flip-flop circuit, there is always a period of time, typically immediately before a clock edge, where the input can change but that change may or may not be reflected in the output of the D-type flip-flop circuit. Thus, if multiple trigger signals are captured by a D-type flip-flop circuit during such period of uncertainty, the interpretation of the resultant output from the D-type flip-flop circuit can be chaotic. For example, multiple trigger signal capturings may occur in synchronizing flip-flop circuit 22 and each of the D-type flip-flop circuits within register 14 during a period of uncertainty. However, due to the gray code nature of delay lines 27a-27n, only one of the inputs can fall into the period of uncertainty for any asynchronous event. That still, however, leaves the possibility that two asynchronous events being captured during a period of uncertainty. A misinterpretation of such two signals can result in an error of plus/minus one clock signal period instead of the true resolution. To avoid such uncertainty, the output from register 14 is preferably taken as the correct answer, and if there is a disagreement between the information contained in the output from register 14 and the output state of synchronizing flip-flop circuit 22. An Enable signal from adjustment circuit 23 is advanced or retarded as necessary to correct the output of synchronizing flip-flop circuit 22. In such situation, adjustment circuit 23 will logically select the last true output of register 14, and upon a rising edge of a signal from synchronizing flip-flop circuit 22 will output an Enable signal to an enable input of latch 24. The Enable signal is also used to reset event flip-flop circuit 21 via a reset input of event flip-flop circuit 21 to its quiescent state.

The m bits from latch 24 and the n bits from gray code-to binary converter 18 are subsequently concatenated by a cascade circuit 25 to become an output having m+n bits. The m+n bits output is then sent to an output line 28.

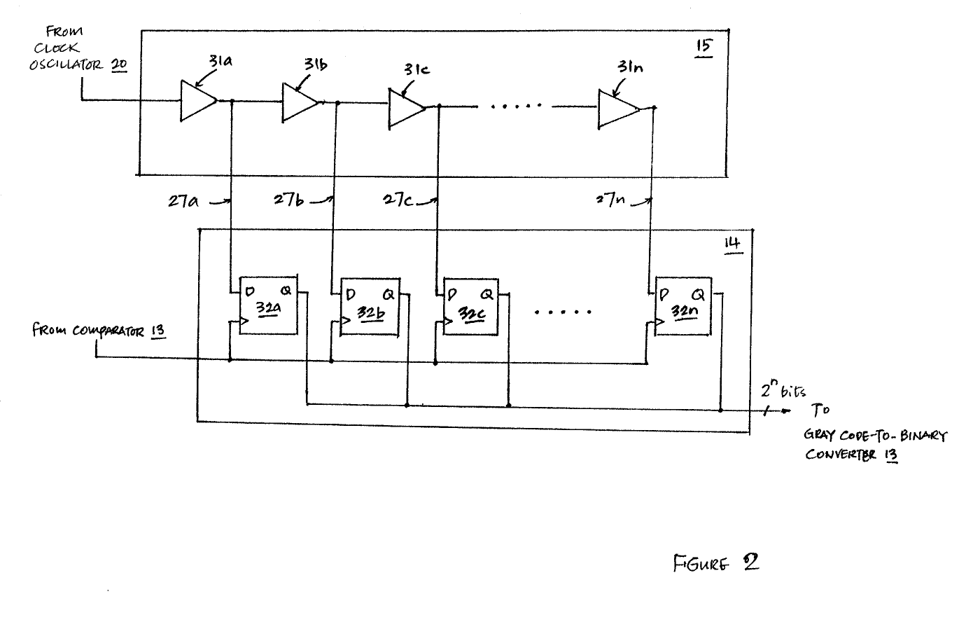

With reference now to FIG. 2, there is illustrated a detailed block diagram of delay circuit 15 and register 14, in accordance with a preferred embodiment of the present invention. As shown, delay circuit 15 includes delay elements 31a-31n, and register 14 includes D-type flip-flop circuits 32a-32n. Each of delay elements 31a-31n may be formed by two inverters connected in series, but preferably, each of delay elements 31a-31n is formed with a lumped inductor-capacitor circuit with the capacitor connected to ground. The output of each of delay elements 31a-31n is connected to the input (D) of each of flip-flop circuits 32a-32n via a respective one of delay lines 27a-27n. The outputs (Q) of flip-flop circuits 32a-32n are all coupled to gray code-to-binary converter 18 (from FIG. 1). The clock inputs of flip-flop circuits 32a-32n are provided by the output of comparator 13 (from FIG. 1). The total number of delay elements 31a-31n, and accordingly flip-flop circuits 32a-32n, is preferably in the power of 2.

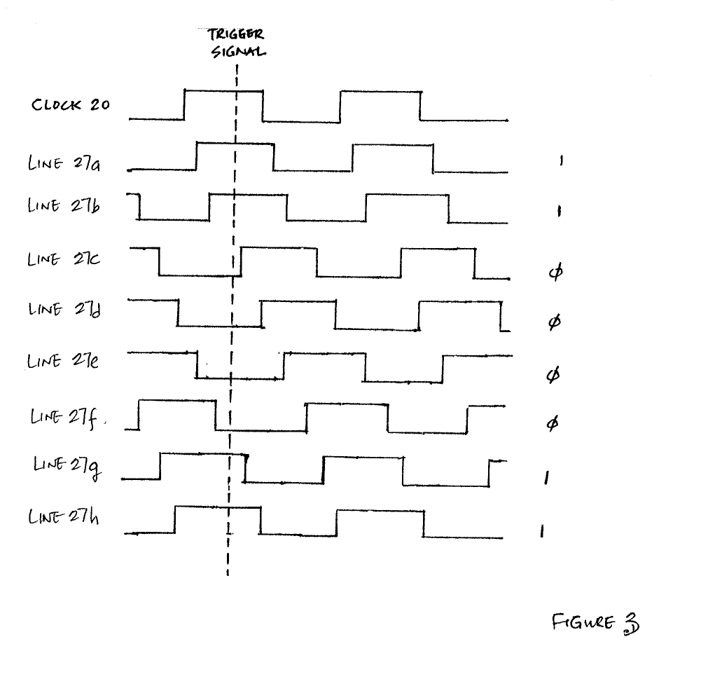

Referring now to FIG. 3, there is illustrated a timing diagram depicting the waveforms generated by various delay lines from delay circuit 15 (from FIG. 2), in accordance with a preferred embodiment of the present invention. The clock signal from clock oscillator 20 is the reference clock signal for delay circuit 15. In this example, delay circuit 15 has eight delay elements, and each of the eight delay elements provides a respective delay line, namely, delay lines 27a-27h. When a trigger signal arrives at the , clock input of register 14 (from FIG. 2), a snapshot of the state of each delay lines 27a-27h at that instant is captured by a respective flip-flop circuit within register 14. Preferably, a positive pulse on a delay line is captured as a logical “1,” and a negative pulse on a delay line is captured as a logical “0.” Thus, the states of delay lines 27a-27h shown in FIG. 3 are captured as “111000011.” As mentioned previously, the captured bits (2″ bits) are preferably in gray code form. Gray code is an ordering of binary numbers such that only one bit changes from one entry to the next. (Technically, the captured bits are not gray code bits because one bit changes from a logical “1” to a logical “0” while another bit changes from a logical “0” to a logical “1.” However, the transition from a logical “0” to a logical “1” is ignored in translating the captured bits, so the captured bits can be treated as gray code bits.) The 2″ captured bits are then converted by gray code-to-binary converter 18 (from FIG. 1) to a binary number of n bits. The n bits represent the fraction of the interval between m clock periods.

An alternative embodiment of timing circuit 10 can be implemented by sending the trigger signal to the input of delay lines 27a-27n, and capturing the state of delay element 31a-31n at the instant of a clock edge to determine the fraction of a clock period before the trigger signal. Event flip-flop circuit 21, synchronizing flip-flop circuit 22, and adjustment circuit 23 are still required for the alternative embodiment.

In summary, the length of one complete clock signal from clock oscillator 20 is divided by the total number of delay lines within delay circuit 15, thereby matching the delay to the period of a clock signal. An asynchronous event, in the form of a trigger signal, triggers the capture of the elapsed time of the clock in counter 16, and the point in the clock cycle of the receipt of the asynchronous event. For the point in the clock cycle, the state of the delay lines within delay circuit 15 is captured by register 14 to provide a set of bits in gray code form. The gray code bits are then converted to binary bits to represent a precise fraction of one clock cycle. A precise time of arrival of the asynchronous event can be generated by concatenating the binary bits to the bits from counter 16.

As has been described, the present invention provides an improved digital timing circuit for measuring time of arrival of an asynchronous event. The accuracy of the timing circuit of the present invention is limited only by the aperture jitter or the dispersion that can be held to fractions of a nanosecond.

While the invention has been particularly shown and described with reference to a preferred embodiment, it will be understood by those skilled in the art that various changes in form and detail may be made therein without departing from the spirit and scope of the invention.

What is claimed is:

1. A timing circuit for measuring time of arrival of an asynchronous event, said timing circuit comprising:
a counter for providing a plurality of high-order binary bits, in response to a time of arrival of a trigger signal that denotes an occurrence of an asynchronous event;
a register for providing a plurality of gray code bits, in response to said time of arrival of said trigger signal;
a gray code-to-binary converter, coupled to said counter and said register, for converting said plurality of gray code bits to a plurality of low-order binary bits; and
a cascade circuit, coupled to said gray code-to-binary converter, for concatenating said plurality of high-order binary bits and low-order binary bits to form said time of arrival of said asynchronous event.

2. The timing circuit of claim 1, wherein said register includes a plurality of flip-flop circuits.

3. The timing circuit of claim 1, wherein said timing circuit further includes a delay circuit coupled to said register.

4. The timing circuit of claim 3, wherein said timing circuit further includes a clock coupled to said counter and said delay circuit.

5. The timing circuit of claim 3, wherein said delay circuit includes a plurality of delay elements.

6. The timing circuit of claim 5, wherein one of said delay elements includes a lumped inductor-capacitor circuit.

7. The timing circuit of claim 1, wherein said timing circuit further includes an event circuit for arbitrating results between said counter and said register.

8. The timing circuit of claim 7, wherein said event circuit includes an event flip-flop circuit, a synchronizing flip-flop circuit, and an adjustment circuit.

9. The timing circuit of claim 1, wherein a value of said gray code bits represents a faction of a clock period that has expired in response to said time of arrival of said trigger signal.

10. The timing circuit of claim 1, wherein said plurality of high-order binary bits represents said time of arrival of said asynchronous event.

11. The timing circuit of claim 1, wherein said plurality of low-order binary bits represents a faction of a clock period within said time of arrival of said asynchronous event.

12. A method for measuring time of arrival of an asynchronous event, said method comprising:
counting clock pulses between an initiating event and an arrival of an asynchronous event, wherein said counted clock pulses are in the form of a binary number representing an elapsed time between said initiating event and said arrival of said asynchronous event;
recording a time of said arrival of said asynchronous event within a period of one of said clock pulses;
generating said recorded time as a plurality of gray bits;
converting said gray code bits to a binary number representing a fraction of a clock period; and
combining said binary number representing an elapsed time between said initiating event and said arrival of said asynchronous event and said binary number representing said fraction of said clock pulse to form said time of arrival of said asynchronous event.

13. The method of claim 12, wherein said initiating event is an reference event.

14. The method of claim 12, wherein said combining further includes concatenating said binary number representing an elapsed time between said initiating event and said arrival of said asynchronous event and said binary number representing said fraction of said clock pulse to form said time of arrival of said asynchronous event.
